(19) United States
(12) Patent Application Publication
(10) Pub. No.: US 2006/0134498 A1
(43) Pub. Date: Jun. 22, 2006

(54) Fuel cell stack and method of making same

(76) Inventors: Robert L. Hamm, Saratoga Springs, NY (US); Kurt N. Laurer, Saratoga Springs, NY (US); Gregory C. Pacifico, Latham, NY (US)

Correspondence Address: TROP PRUNER & HU, PC, 8554 KATY FREEWAY, SUITE 100, HOUSTON, TX, 77024, US

(21) Appl. No.: 11/020,636

(22) Filed: Dec. 22, 2004

(51) Int. Cl. H01M 8/02; H01M 2/08

(52) U.S. Cl. 429/37; 429/38; 429/36

(57) ABSTRACT

A fuel cell system includes a fuel cell stack that includes fuel cell plates. The fuel cell system includes a retainer to maintain a total compression force on the fuel cell plates between approximately 5 to 40 pounds per square inch.

### GOVERNMENT LICENSE RIGHTS

The U.S. Government has a paid-up license in this invention and the right in limited circumstances to require the patent owner to license others on reasonable terms as provided for by the terms of Contract No. DE-FC36-03G013101 awarded by the Department of Energy.

### BACKGROUND

The invention generally relates to a fuel cell stack and a method of making the fuel cell stack.

A fuel cell is an electrochemical device that converts chemical energy produced by a reaction directly into electrical energy. For example, one type of fuel cell includes a proton exchange membrane (PEM), that permits only protons to pass between an anode and a cathode of the fuel cell. Typically PEM fuel cells employ sulfonic-acid-based ionomers, such as Nafion, and operate in the 60° Celsius (C) to 70° temperature range. Another type employs a phosphoric-acid-based polybenziamidazole, PBI, membrane that operates in the 150° to 200° temperature range. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The fuel cell stack is one out of many components of a typical fuel cell system, as the fuel cell system includes various other components and subsystems, such as a cooling subsystem, a cell voltage monitoring subsystem, a control subsystem, a power conditioning subsystem, etc. The particular design of each of these subsystems is a function of the application that the fuel cell system serves.

The flow plates of the fuel cell stack typically are compressed between end plates. Tie rods typically extend through the end plates to maintain a compression force on the flow plates of the fuel cell stack. More specifically, each tie rod may be bolted at one end to one of the end plates, and at the other end plate, a compressive spring may be located between the end of the tie rod and the end plate. The result of this arrangement is that typically, a compression force that exceeds about 80 pounds per square inch (psi) is exerted on the flow plates.

The compression force is exerted on the flow plates for purposes of maintaining tight contact between various plates and maintaining seals around the flow areas of each flow plate. In this regard, a typical flow plate includes an active flow area as well as various manifold openings for purposes of communicating coolant, fuel and oxidant throughout the fuel cell stack. When the flow plates are arranged to form the stack, these manifold openings align to create manifold passageways through the fuel cell stack. Mechanical seals between the plates isolate the different flows in the fuel cell stack from each other. Conventionally, the seals are formed from pre-molded elastomeric gaskets that are placed between adjacent flow plates when the fuel cell stack is assembled and squeeze out to close off any microscopic gaps between the plates when compression force is applied to the stack.

A potential difficulty in the above-described arrangement is that such mechanical seals tend to leak, and in maintaining the above-described compression load (a load greater than 80 psi) on the fuel cell stack, fairly expensive end hardware may be required. Thus, there is a continuing need for better ways to seal and reduce the cost and complexity of a fuel cell stack.

### SUMMARY

In an embodiment of the invention, a fuel cell system includes a fuel cell stack that includes flow plates. The fuel cell system includes a retainer to exert a total compression force on the flow plates between approximately 5 to 40 pounds per square inch, in some embodiments of the invention.

In another embodiment of the invention, an apparatus that is usable with a fuel cell system includes a first flow plate and a second flow plate. The first flow plate communicates a fuel flow to an anode side of a fuel cell. The second flow plate communicates an oxidant flow to a cathode side of the fuel cell. The apparatus includes a non-conductive chemical bond using an adhesive or cement that secures the first flow plate to the second flow plate and provides a seal to isolate the flows in the fuel cell stack.

In another embodiment of the invention, a technique includes stacking fuel cell flow plates together to form a stack and operating a mechanism so that the mechanism has a position at which the mechanism applies a compression force on the stack. The compression force may initially exceed-the strength of the uncured or partially cured adhesive or cement. The technique includes without changing the position of the mechanism, allowing an internal effect in the stack to relax the compression force to a force that is equal to or less than the bond strength. The technique includes in response to the compression force relaxing below the bond strength, forming bonds between the fuel cell flow plates.

In yet another embodiment of the invention, a fuel cell system includes a fuel cell stack, a first adhesive or cement layer and a second adhesive or cement layer. The first adhesive or cement layer is located between the flow plates to provide a seal to isolate flows in the fuel cell stack; and the second adhesive layer provides a bond that secures the first flow plate to the second flow plate.

Advantages and other features of the invention will become apparent from the following drawing, description and claims.

### BRIEF DESCRIPTION OF THE DRAWING

FIGS. 1, 4 and 10 are front views of fuel cell stacks according to embodiments of the invention.

FIG. 2 is an exploded front view of a portion of a fuel cell stack according to an embodiment of the invention.

FIG. 3 is a flow diagram depicting a technique to form a fuel cell stack according to an embodiment of the invention.

FIGS. 5 and 13 are top views of flow plates of a fuel cell stack according to different embodiments of the invention.

FIG. 6 is a cross-sectional view taken along line 6-6 of FIG. 5 according to an embodiment of the invention.

FIGS. 7 and 14 are cross-sectional views depicting a seal formed between adjacent flow plates of a fuel cell stack according to different embodiments of the invention.

FIGS. 8, 9, 12 and 15 are flow diagrams depicting techniques to form a fuel cell stack according to embodiments of the invention.

FIG. 11 is a block diagram of a fuel cell system according to an embodiment of the invention.

### DETAILED DESCRIPTION

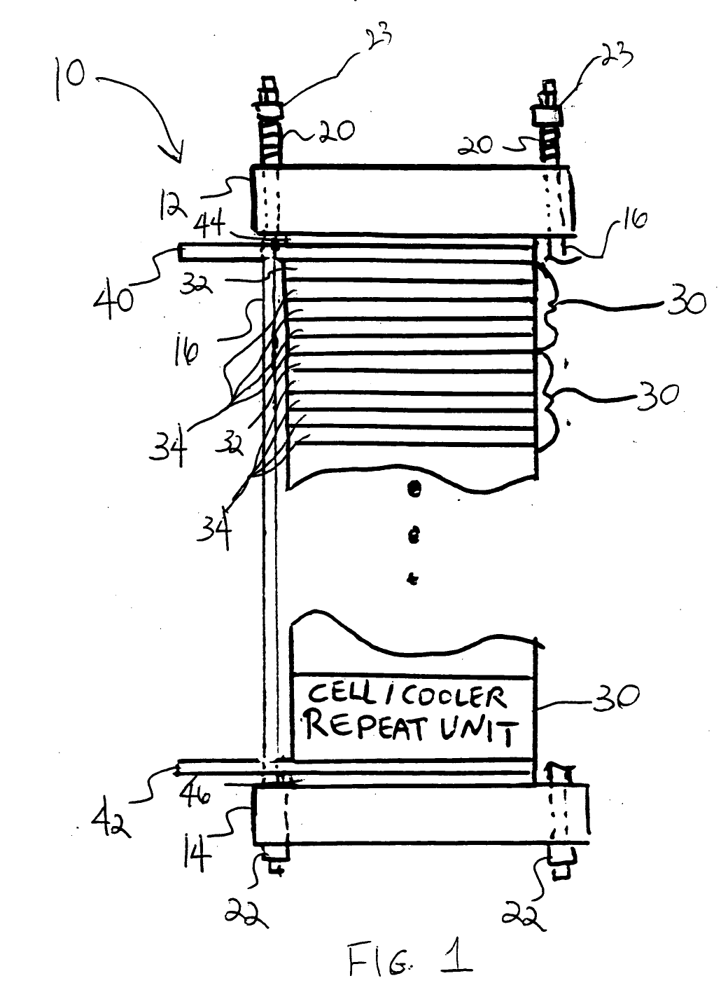

Referring to FIG. 1, an embodiment of a fuel cell stack 10 (a stack that forms PEM-type fuel cells, for example) in accordance with the invention includes flow plates that are stacked together and held under compression by upper 12 and lower 14 end plates. In this regard, in some embodiments of the invention, tie rods 16 extend through the upper 12 and lower 14 end plates to hold the flow plates between the end plates 12 and 14 in compression. As depicted in FIG. 1, each tie rod 16 (two tie rods depicted in FIG. 1, as examples) may have a bottom end that is secured to the bottom end plate 14 (also called the “blind end plate”) via a thread and nut connection. The upper end of the tie rod 16 may be arranged so that a spring 20 circumscribes the tie rod 16 and is connected to the tie rod 16 via an upper nut and thread connection 23. Each spring 20 is located between the connection 23 and the upper end plate 12 (also called the “service end plate”). Thus, due to this arrangement, the springs 20 are compressed during the assembly of the fuel cell stack 10 to thereafter maintain a compression force on the flow plates of the fuel cell stack 10.

It has been discovered that under certain circumstances a compression load (a load between approximately 80 to 100 pounds per square inch (psi) is not necessary to maintain proper operation of the fuel cell stack. More specifically, it has been discovered that for stacks employing thick membranes (a membrane less than approximately 0.004 inches, for example) such as PBI-type membranes (operation between 150° Celsius (C) to 200° C.), the actual compression load on the flow plates of the fuel cell stack is dramatically lower than the load (80 psi to 100 psi) imparted at the time of assembly of the stack due to rapid creep of the PBI membrane. However, even with these reduced loads the cells performed well, and thus, it has been discovered that the compression force that is applied to the fuel cell stack may be reduced at the time of assembly of the stack 10.

Therefore, in accordance with an embodiment of the invention, a significantly lower compression force (a compression force between 5 to 40 psi, for example) is imparted to the flow plates of the fuel cell stack 10 at the time of the stack's assembly, and several advantages flow from this feature.

For example, due to the reduction of the compression load used at the time of assembly, lower cost and less complex end hardware may be used to hold the flow plates of the fuel cell stack 10 in compression. Thus, the tie rods 16 may be generally smaller in diameter (and less expensive) than the tie rods of conventional fuel cell stacks; the springs 20 may be generally smaller (and less expensive) than springs of conventional fuel cell stacks to exert less compressive force than conventional stacks; fewer tie rods 16 may be used than in conventional fuel cell stacks; or no rods or springs may be required at all, the compression load being carried totally by the bond created by the adhesive or cement. All of these changes may greatly reduce the cost and complexity of the fuel cell stack 10.

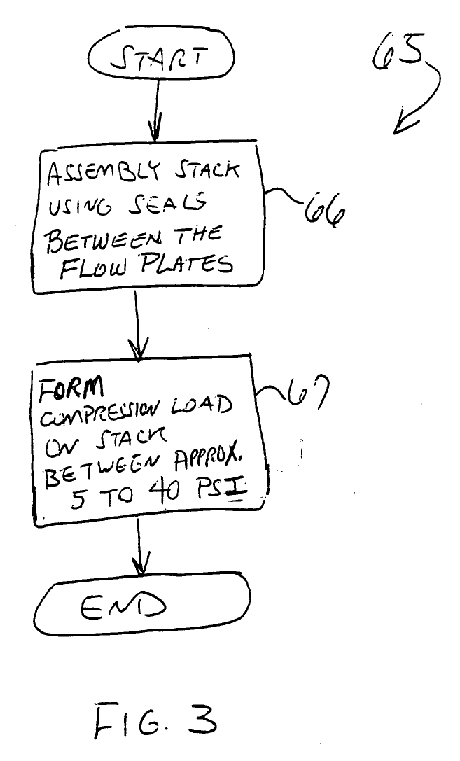

Thus, referring to FIG. 3, in accordance with some embodiments of the invention, a technique 65 for assembling a fuel cell stack includes assembling the stack using seals (drop-in pre-molded gasket seals or other seals, as further described below) between adjacent flow plates, as depicted in block 66. The technique 65 includes forming a compression load on the stack between approximately 5 psi to 40 psi at the time of assembly, as depicted in block 67.

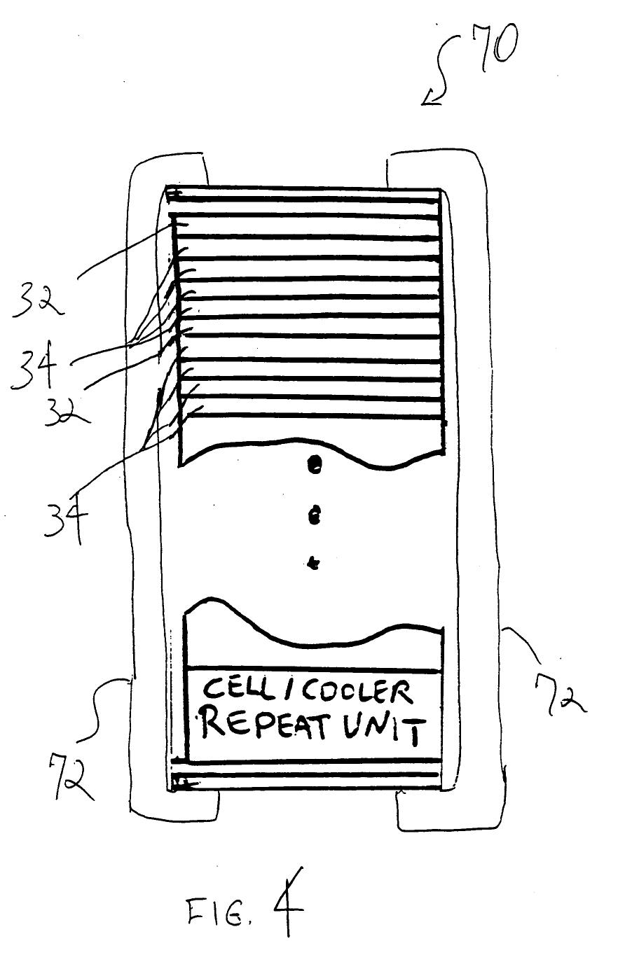

In some embodiments of the invention, the tie rods 16, springs 20 and upper 12 and lower 14 end plates may be eliminated all together and replaced with less complex and less expensive clips (plastic clips, for example). For example, referring to FIG. 4, in some embodiments of the invention, the fuel cell stack 10 of FIG. 1 may be replaced by a fuel cell stack 70. The fuel cell stack 70, unlike the fuel cell stack 10, does not contain end plates, tie rods, springs, etc. for purposes of maintaining a compression force on the flow plates of the fuel cell stack 70. Instead, clips 72, such as plastic clips, are flexed at the time of assembly of the fuel cell stack 10 so that the top and bottom ends of each clip 72 extend over the bottom and top surfaces of the plate stack for purposes of exerting a compressive force (a force between approximately 5 and 40 psi, for example) on the stack 70. Thus, many variations are possible and are within the scope of the appended claims.

Referring back to FIG. 1, in some embodiments of the invention, the flow plates of the fuel cell stack 10 (and the fuel cell stack 70 of FIG. 4) may be arranged in the following manner. In accordance with some embodiments of the invention, the flow plates may be arranged in a stacking pattern represented in FIG. 1 by a cell/cooler repeat unit 30. Each unit 30 includes a cooler flow plate 32 and additional bipolar flow plates 34 that form four fuel cells. Therefore, due to this arrangement, the fuel cell stack 10 includes a cooler flow plate 32 that is interdisposed in the fuel cell stack between every four fuel cells. It is noted that the arrangement that is depicted in FIG. 1 and described herein is merely an example of one embodiment of a fuel cell stack in accordance with the invention. Thus, many other variations (two fuel cells per cooler plate, one fuel cell per cooler plate, eight fuel cells per cooler plate, etc.) are possible and are within the scope of the appended claims. It is assumed for purposes of simplifying the discussion herein that the unit 30 includes four fuel cells per cooler plate. As a further example, the fuel cell stack 10 may have about 20 to 30 units 30 to form approximately 80 to 120 cells, in some embodiments of the invention.

The bipolar flow plate 34 includes flow channels on one face of the plate to communicate an anode flow through the anode side of an associated fuel cell; and on the other face of the bipolar flow plate 34, the bipolar flow plate 34 includes flow channels to route an oxidant flow to the cathode side of another adjacent fuel cell. As a more specific example, in some embodiments of the invention, the lower face of the bipolar flow plate 34 may include flow channels that communicate an anode flow; and the upper face of each bipolar flow plate 34 may include flow channels that communicate an oxidant flow.

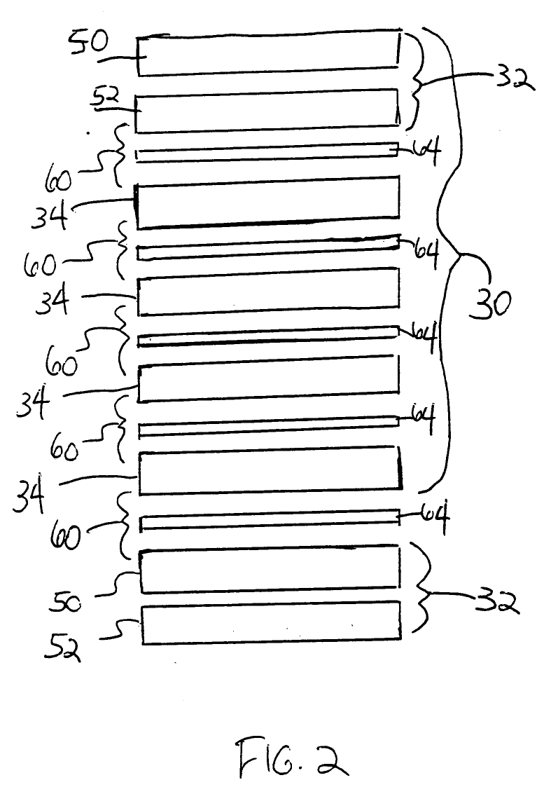

FIG. 2 depicts a portion of the fuel cell stack of FIG. 1 according to an embodiment of the invention. More specifically, FIG. 2 depicts the flow plates and membrane electrode assemblies (MEAs) 64 of associated fuel cells 60. Referring to FIG. 2, in some embodiments of the invention, each cooler flow plate 32 is formed from two adjacent flow plates: an upper cathode cooler flow plate 50 and a lower anode cooler flow plate 52. The lower face of the upper cathode cooler flow plate 50 includes flow channels to communicate a coolant. These flow channels are “half” flow channels in that the flow channels align with corresponding coolant flow channels on the upper face of the lower anode cooler flow plate 52. Thus, when the cathode 50 and anode 52 cooler flow plates are assembled together, coolant flow passageways are created in the region near the union of the two plates 50 and 52.

In some embodiments of the invention, the cathode cooler flow plate 50, on its upper face, includes flow channels to communicate an oxidant flow to an associated fuel cell 60. Thus, these oxidant flow channels; an MEA 64 located above the oxidant flow channels; and anode flow channels that are formed in the lower face of the bipolar flow plate 34 that is located above the MEA 65, form an associated fuel cell 60.

The anode cooler flow plate 52 has flow channels on its lower face to communicate a fuel flow to the anode side of an associated fuel cell 60. Therefore, a fuel cell 60 is formed from the anode flow channels on the lower face of the anode cooler flow plate 52; an MEA 64 that is located directly below the anode flow channels, and oxidant flow channels that are present on the upper face of an adjacent bipolar flow plate 34.

As stated above, each bipolar flow plate 34 has an upper face that contains cathode flow channels and a lower face that contains anode flow channels. Therefore, the upper face of each bipolar flow plate is associated with the cathode side of a fuel cell 60; and the lower face of each bipolar flow plate 34 is associated with the anode side of another fuel cell 60.

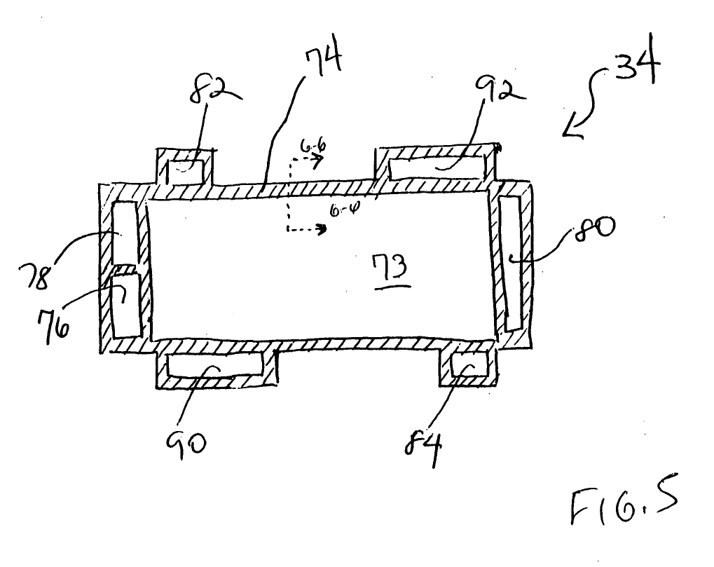

FIG. 5 depicts an exemplary top view of a bipolar flow plate 34 in accordance with an embodiment of the invention. The bipolar flow plate 34, similar (in general) to the other flow plates of the fuel cell stack, includes several manifold passageway openings for purposes of communicating reactant and coolant flows throughout the fuel cell stack. More specifically, each flow plate, such as the bipolar flow plate 34, includes these manifold passageway openings so that when the flow plates are assembled to form the fuel cell stack, the manifold openings align to form corresponding manifold passageways through the fuel cell stack. Thus, when assembled, the fuel cell stack includes a fuel supply manifold passageway, a fuel return manifold passageway, a coolant supply manifold passageway, a coolant return manifold passageway, an oxidant supply manifold passageway and an oxidant supply manifold passageway. Furthermore, in some embodiments of the invention, the fuel cell stack may include a fuel turnaround manifold passageway, a passageway that may be used to, for example, reroute a fuel flow exhaust from one fuel cell back into a fuel flow intake of another fuel cell.

As a more specific example, the upper face of the bipolar flow plate 34 (depicted in FIG. 5) includes an oxidant supply manifold passageway opening 90 that communicates an incoming oxidant flow to an oxidant flow region 73 of the bipolar flow plate 34. Although not depicted in FIG. 5, the flow region 73 includes flow channels (serpentine flow channels, for example) that communicate the oxidant flow from the oxidant supply manifold passageway opening 90 through the flow region 73 and to an oxidant return manifold passageway opening 92 of the bipolar flow plate 34. The manifold openings 90 and 92 form parts of corresponding oxidant supply and return manifold passageways, respectively, of the fuel cell stack.

Although the upper face of the bipolar flow plate 34 includes the flow region 73 that communicates an oxidant flow, the bipolar flow plate 34 also includes manifold opening passageways that form parts of other manifold passageways of the fuel cell stack. For example, the bipolar flow plate 34 includes a fuel supply manifold passageway opening 76, a turnaround fuel manifold passageway opening 80 and a fuel return manifold passageway opening 78. It is noted that the lower face of the bipolar flow plate 34 (not depicted in FIG. 5) has a flow region to communicate a fuel flow between the manifold passageway openings 76, 78 and 80.

The bipolar flow plate 34 also includes a coolant supply manifold passageway opening 82 and a coolant return manifold passageway opening 84 that form parts of coolant inlet and coolant return manifold passageways, respectively, of the fuel cell stack. It is noted that for the cooler flow plates, the cooler flow plates include flow regions to communicate coolant flow between their coolant supply 82 and return 84 manifold passageway openings.

Due to the various flows that are routed through each flow plate of the fuel cell stack, a seal or multiple seals are formed to isolate the flows from each other. Thus, as depicted in FIG. 5, a seal region 74 exists between the flow region 73 and the various manifold passageway openings to isolate the coolant, fuel and oxidant flows from each other.

In general, the seal region 74 is the region of the bipolar flow plate 34 in which a seal is formed between the flow plate 34 and another like seal region of the adjacent flow plate (bipolar or cooler flow plate). The lower face of the bipolar flow plate 34, as well as the upper and lower faces of the cooler plate 32 (FIG. 1), also contain similar seal regions. The seal region of each of these faces is electrically non-conductive for the upper and lower faces of the bipolar flow plate 34, in that both the upper and lower faces of the bipolar flow plate 34 form different sides of a fuel cell. If the regions were otherwise electrically conductive, the fuel cell would be shorted. However, for the faces of the cooler plate, the corresponding seal region is electrically conductive in that the cooler plate bridges the anode of one fuel cell to the cathode of the next fuel cell in series. The flow region 73 is electrically conductive both for the upper and lower faces of the bipolar plate 34, as well as for the cooler flow plate.

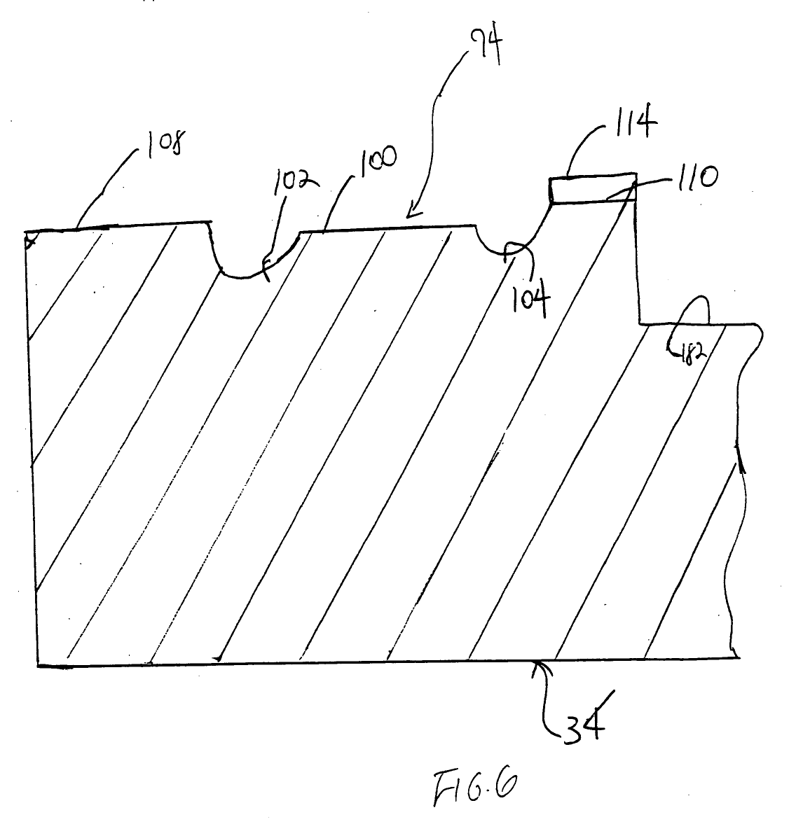

FIG. 6 depicts a cross-sectional view taken along line 6-6 of FIG. 5 and illustrates certain sealing features of the region 74 in accordance with some embodiments of the invention. As described below, in some embodiments of the invention, adjacent flow plates of the fuel cell stack are bonded together (via an adhesive, for example). Thus, this bonding replaces conventional drop-in pre-molded gasket seals.

Referring to FIG. 6, more specifically, in some embodiments of the invention, in the seal region 74, the upper surface of the bipolar flow plate 34 includes a land 100 that receives an adhesive (cement, for example) for bonding the upper surface of the bipolar flow plate 34 to the lower surface of the adjacent flow plate in the fuel cell stack. Gutter grooves 102 and 104 extend along each edge of the land 100 for purposes of receiving any excess adhesive that is forced from the land 100 when the two flow plates (the bipolar flow plate 34 and the adjacent flow plate) are compressed together. The land 100 is sufficiently recessed to define a predetermined thickness for the adhesive layer when the flow plates are pressed together. For purposes of providing a mechanical stop to limit the degree in which adjacent flow plates may be compressed together (and thus, work together with the land 100 to form a predetermined thickness of the adhesive layer), the bipolar flow plate 34 includes a hard stop shoulder 108. In some embodiments of the invention, the shoulder 108 is located between the gutter groove 102 and the outer side edge of the bipolar flow plate 34.

Among its other features, in some embodiments of the invention, the bipolar flow plate 34 includes a groove 182 (part of which is depicted in FIG. 6) that receives an MEA that is located between the upper face of the bipolar flow plate 34 and the lower face of the adjacent bipolar flow plate. The groove 182 forms the lower half of a corresponding cavity that receives the MEA when adjacent flow plates are assembled together. In some embodiments of the invention, the seal region 74 also includes another hard stop shoulder (not depicted in FIG. 6).

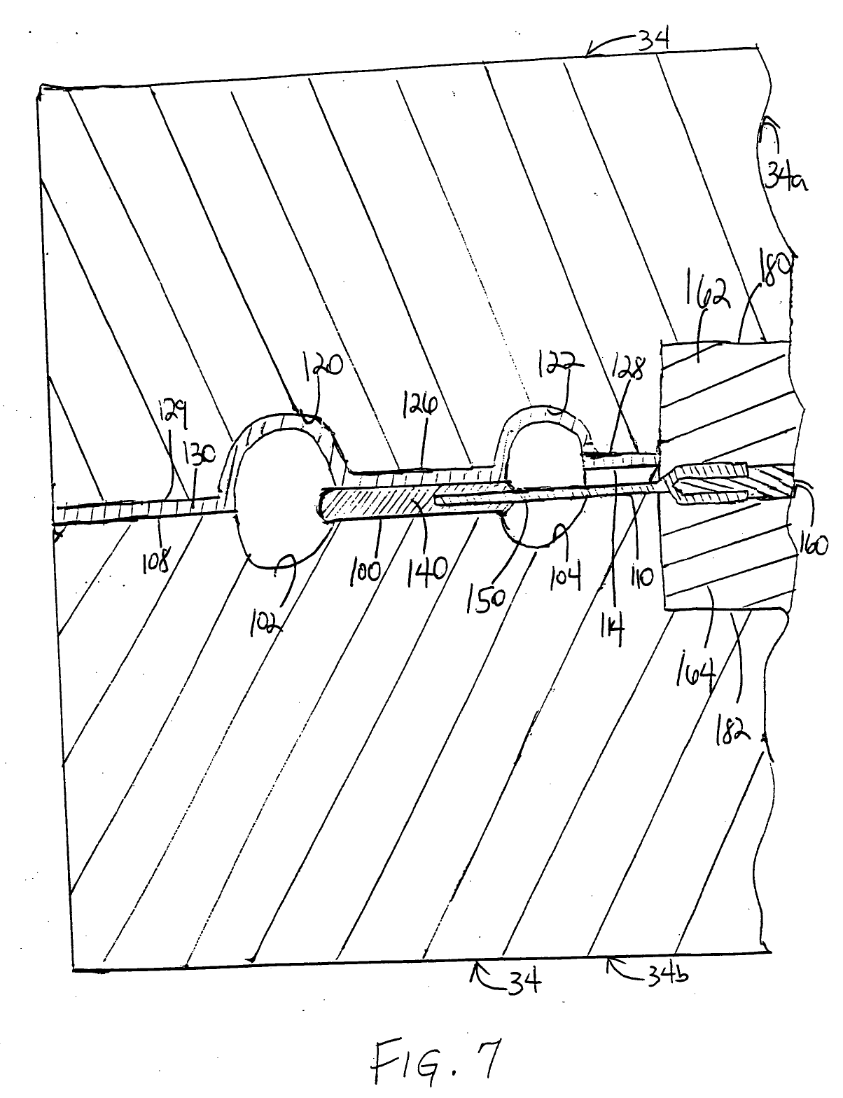

FIG. 7 depicts the bipolar flow plate cross-section of FIG. 6 when the bipolar flow plate 34 of FIG. 6 is assembled inside the fuel cell stack. More specifically, FIG. 7 depicts an exemplary cross-section of a lower bipolar flow plate 34b (i.e., the cross-section depicted in FIG. 6) and an exemplary cross-section of an adjacent upper bipolar flow plate 34a. These cross-sections illustrate features of the adjacent seal regions, as further described below.

Referring to FIG. 7, the upper bipolar flow plate 34a includes, on its lower surface, a land 126 that corresponds to and extends in the same direction as the land 100 of the lower bipolar flow plate 34b. Furthermore, the bipolar flow plate 34a includes hard stop shoulders 129 and 128 that correspond to and extend along the corresponding hard stop shoulders 108 and 110, respectively, of the lower bipolar flow plate 34b. Due to this arrangement, when the bipolar flow plates 34a and 34b are assembled together, a predefined vertical gap exists between the lands 100 and 126 to define a predetermined thickness for an adhesive layer 140.

Regarding the adhesive layer 140, before the upper 34a and lower 34b bipolar flow plates are assembled together, a bead of adhesive is applied to the land 100; and this bead follows the seal region 74 (see FIG. 5, for example). Therefore, after the upper 34a and lower 34b bipolar flow plates are assembled together, the lands 100 and 126 approach each other to form a uniform thickness for the adhesive layer 140.

The upper surface of the bipolar flow plate 34a also includes gutter grooves 120 and 122 that extend along the land 126 and extend with the gutter grooves 102 and 104, respectively. Due to this arrangement, the gutter grooves 102 and 120 form a closed channel that extends on one side of the lands 100 and 126 and around the seal region 74 for receiving excess adhesive that does not end up in the layer 140; and the gutter grooves 104 and 122 form a closed channel that extends around the seal region 74 for also receiving excess adhesive that does not end up in the layer 140 on the other side of the lands 126 and 100. Therefore, the adhesive layer 140 always has the same thickness, in that a sufficient bead of adhesive is formed in the seal region (see FIG. 5) to ensure that the adhesive layer 140 has its maximum thickness, which means adhesive ends up in the gutter grooves.

As also depicted in FIG. 7, a dielectric layer 130 is placed over a portion of the seal region on the lower face of the upper bipolar flow plate 34a before the bipolar flow plates 34a and 34b are assembled together. The dielectric layer 130 provides electrical isolation between the seal regions 74 of the respective bipolar flow plates. As shown in FIG. 7, the dielectric layer 130 does not extend into the MEA area of the bipolar flow plates 34a and 34b.

The upper bipolar flow plate 34a includes an upper groove 180 that corresponds to and extends over the same region as the lower groove 180 of the lower bipolar flow plate 34b. Therefore, when the bipolar flow plates 34a and 34b are assembled together, the grooves 180 and 182 form a cavity to receive the MEA. As depicted in FIG. 7, the MEA includes gas diffusion layers/electrodes 162 and 164 that sandwich the membrane 160. Furthermore, a framing (a Kapton® layer, for example) 150 of the MEA may extend from the MEA cavity, rest on the shoulder 110 and extend into the adhesive layer 140, in some embodiments of the invention.

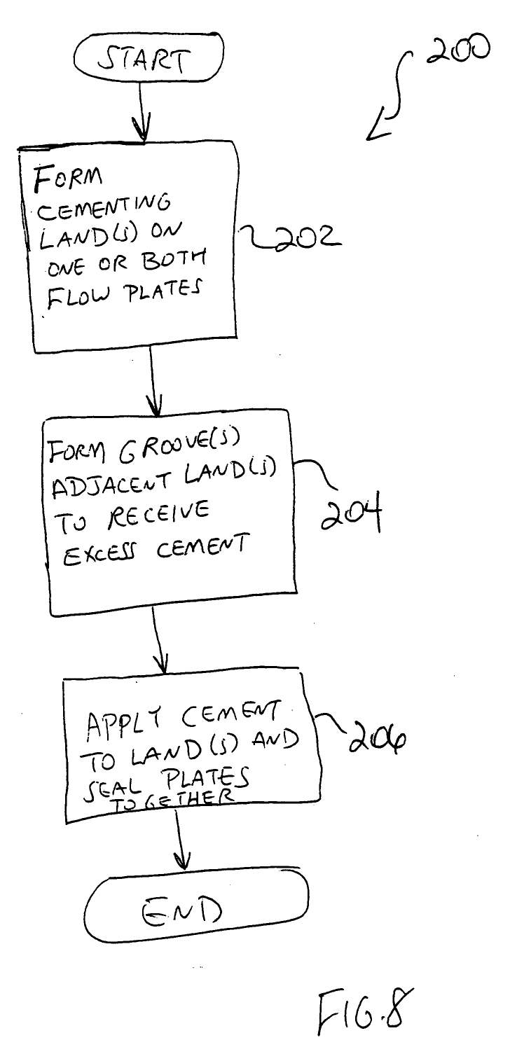

The adhesive may be cement, in some embodiments of the invention. Referring to FIG. 8, thus, in accordance with some embodiments of the invention, a technique 200 for sealing two flow plates together includes forming (block 202) cementing land(s) on one or both of the flow plates. Next, in accordance with the technique 200, one or more groove(s) are formed adjacent to the land(s) to receive excess cement, as depicted in block 204. Subsequently, cement is applied (block 206) to the land(s) so that when the flow plates are assembled, the cement cures and the flow plates are thus, sealed and bonded together.

Adhesives other than cement may be used in other embodiments of the invention. Furthermore, the plate structures that are described above for the seal region 74 may be used in applications in which a bond other than an adhesive bond is formed. In this manner, a plate welding process, such as an ultrasonic, vibration, hot plate, hot gas or a variation thereof may be used in the area of the lands to physically join the surfaces of the plates and the edge of the MEAs together to affect the same type of leak-proof barrier. The dimensions of the land and the adjacent gutter grooves are adjusted to accommodate the requirements of the welding process. Furthermore, an electrically non-conductive substrate is used on one of the cell interfaces to prevent shorting.

It is noted that for bonding cooler flow plates together, the bonding adhesive layer may be preferentially electrically conductive but acceptable if electrically non-conductive.

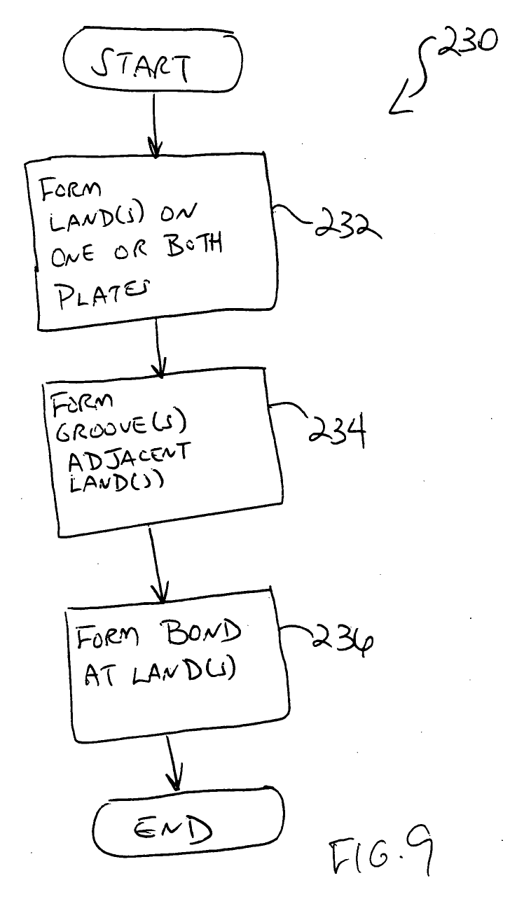

Thus, referring to FIG. 9, a technique 230 may be used to bond two adjacent flow plates together, in accordance with some embodiments of the invention. The technique 230 includes forming (block 232) one or more land(s) on one or both flow plates. Next, in accordance with the technique 230, one or more groove(s) are formed on one or more adjacent land(s), in accordance with block 234. Lastly, a bond is formed (block 236) at the land(s). As stated above, this bond may be formed by an adhesive, such as cement, or may be formed alternatively by a welding process. Therefore, many variations are possible and are within the scope of the appended claims.

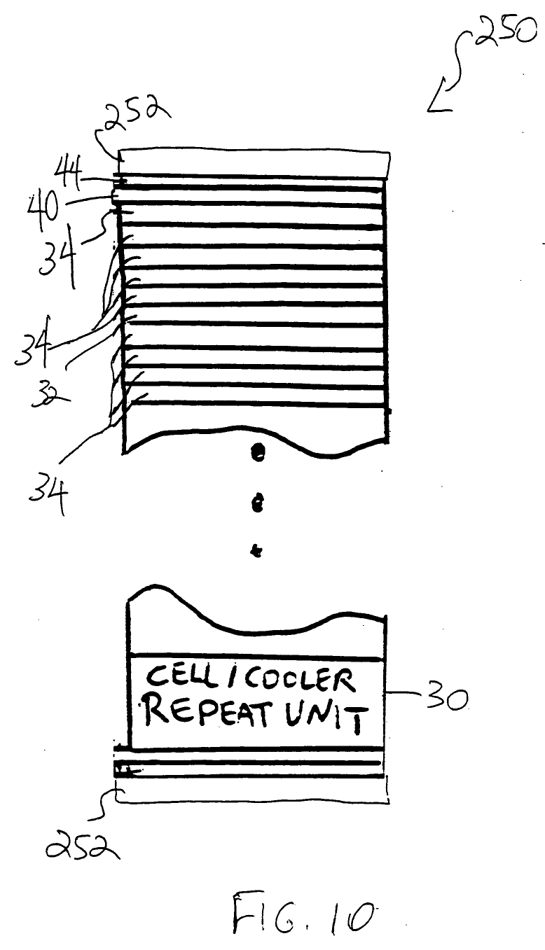

Referring to FIG. 10, due to the above-described bonding between flow plates, a fuel cell stack 250 may be used in some embodiments of the invention. The fuel cell stack 250 does not rely on a large compression force being applied to the plates of the fuel cell stack. Instead, adhesive, welding or another bond secures the flow plates together using much smaller compression force (a force of 5 psi to 40 psi, as an example).

In accordance with some embodiments of the invention, the fuel cell stack 250 may have a similar design to the fuel cell stacks 10 and 70, with the exception that no end hardware, clips, etc. are used to apply a compression force to the flow plates of the fuel cell stack. Instead, the fuel cell stack 250 may include light-weight end caps 252 (plastic end caps, for example) that are located on the upper and lower surfaces of the fuel cell stack 250 to serve a protective function and not apply a significant compression force to the flow plates of the stack 250.

For embodiments of the invention, in which the above-described bonding is used between the flow plates of the fuel cell stack, the material for the flow plates is selected to ensure adhesion with the cements or welding and ensure good sufficient bonding with the dielectric layer. In some embodiments of the invention, the flow plates and other stack substrates each have a low flexural stiffness, such as a stiffness between approximately 1×10⁵ to 2×10⁵ (as an example), to ensure sufficient conformability to facilitate sealing and low load resistivity.

In some embodiments of the invention, a large compression force (a force of 100 psi, for example) is initially applied to the fuel cell stack. However, at the end of a period of about 100 hours or less, the compression force relaxes to about 5 psi to 40 psi. Furthermore, during the continued life of the fuel cell stack, the compression force may relax to even a smaller force. During the initial period (when the compression force is between 40 psi and to 100 psi, for example), the uncured or partially cured joints formed by the welding/adhesive may not be expected to withstand the relatively large compression force. Therefore, in accordance with some embodiments of the invention, the fuel cell stack may be placed in a compression restraint form during this initial period until the compression force relaxes and the cement or adhesive cures.

The initial compression load applied by the press (pursuant to block 604) allows the uncured cement to distribute along the cementing land and permits the elements of the stack to be brought into physical conformity.

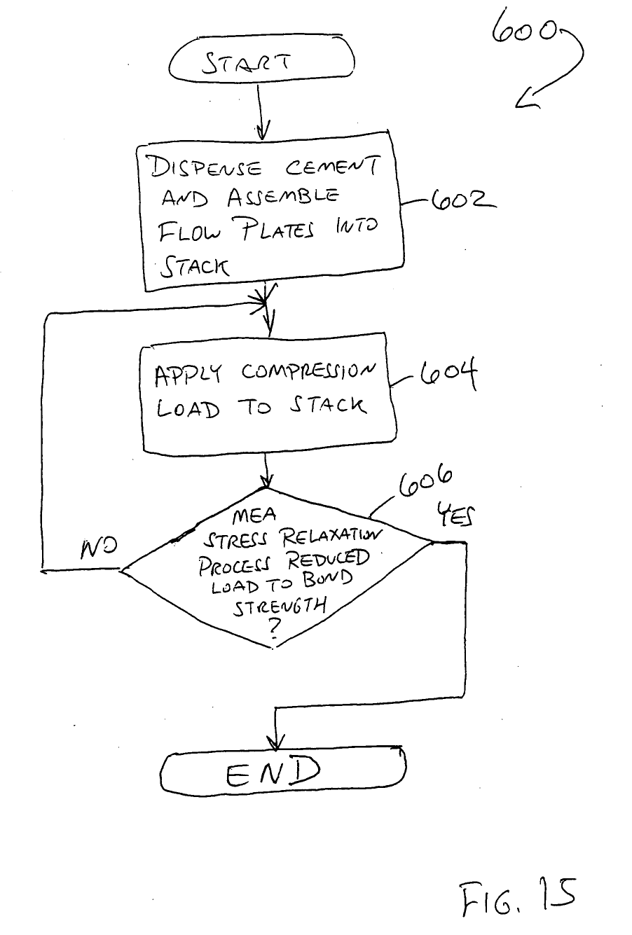

In some embodiments of the invention, a technique 600 that is depicted in FIG. 15 may be used for purposes of assembling fuel cell flow plates and MEAs together to form a fuel cell stack. Referring to FIG. 15, the technique 600 includes dispensing cement along the bond lines on each flow plate just prior to its placement into the stack so that the flow plates are assembled, as depicted in block 602. It is noted that the dispensing of the cement and assembly of the flow plates may be performed in a relatively quick time interval, for purposes of allowing more time for a compression force to relax on the stack, as further described below. More specifically, pursuant to the technique 600, the stack is placed in a mechanism, such as press (for an example) so that the plates of the press are in a position to apply a compression load to the stack, as depicted in block 604.

The initial compression load applied by the press (pursuant to block 604) may be greater than the strength of the uncured or partially cured cement. For example, in some embodiments of the invention, initially, the plates of the press create a total compression force on the stack of 100 psi or greater. However, this relatively large (as compared to the strength of the uncured or partially cured cement) compression force permits the elements of the stack to be brought into physical conformity.

It has been discovered that the total compression force or load on the fuel cell stack decreases over time without changing the relative positions of the compressing plates of the press. In some embodiments of the invention, this decrease is attributable to the MEA stress relaxation process, a relaxation process that eventually reduces the total compression load on the stack to equal or be less than the bond strength of the cement. The MEA stress relaxation process occurs due to membrane creep between the flow plates of the stack.

More specifically, in some embodiments of the invention, thick membranes (individually greater than 0.004 inches, for example), such as (PBI) membranes may be used to form the fuel cells of the stack. With such types of membrane, it has been observed that the creep of the membrane relaxes the total compression force on the stack.

Thus, in accordance with the technique 600, a determination (diamond 608) is made whether the MEA stress relaxation process has reduced the total compression load on the stack to less than the bond strength. If not, the MEA relaxation process continues to reduce the total compression load on the stack. Eventually, the MEA relaxation process reduces the total compression load on the stack to below the bond strength. At that point, the stack may then be removed from the press (block 608).

In some embodiments of the invention, the cathode and anode cooler flow plates are bonded together before stack assembly. This has the advantage of greater flexibility in choosing the technique by which the plates are bonded. However, this technique may not be used in some embodiments of the invention, because it may produce stiffer plate assemblies that are less able to conform to the shape of the stack at a given low compression load.

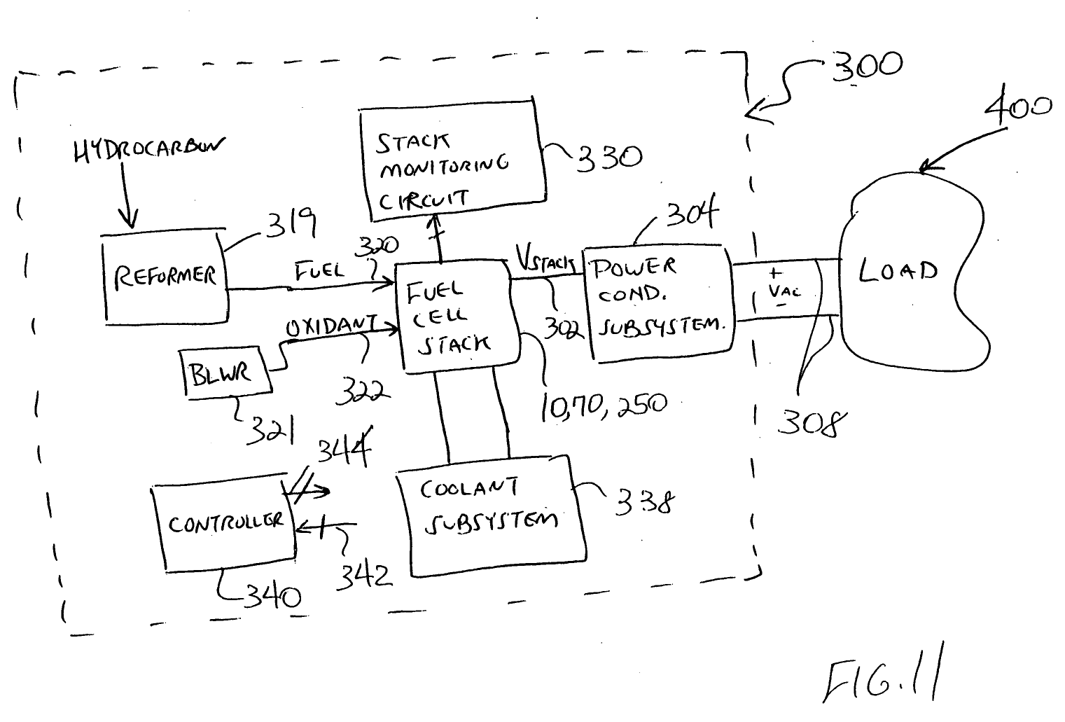

Referring to FIG. 11, the fuel cell stacks (such as the fuel cell stacks 10, 70 and 250, for example) in accordance with the various embodiments that are described herein may be used in a fuel cell system 300. The fuel cell stack of the system 300 receives fuel and oxidant flows at fuel inlet 320 and oxidant inlet 322 ports of the fuel cell stack. The incoming fuel flow may be provided by a reformer 319, and the incoming oxidant flow may be provided by an air blower 321. In response to these flows, the fuel cell stack provides a stack voltage (called “VSTACK”) at its output terminal 302.

Depending on the particular application in which the fuel cell system 300 is used, a power conditioning subsystem 304 may convert the VSTACK stack voltage into an AC voltage that appears on output terminals 308 of the power conditioning subsystem 304. Thus, for example, a load 400 (such as a residential load, for example) may be coupled to the output terminals 308.

The fuel cell system 300 may include various other components and subsystems, depending on the particular embodiment of the invention. For example, the fuel cell system 300 may include a coolant subsystem 338 that circulates coolant through the coolant flow plates of the fuel cell stack. Additionally, the fuel cell system 300 may include such circuitry as a stack monitoring circuit 330 that monitors the cell voltages, stack currents, etc., for purposes of monitoring the operation and health of the fuel cell stack.

Furthermore, in some embodiments of the invention, the fuel cell system 300 may include a controller 340 that includes one or more microcontrollers and/or microprocessors for purposes of controlling and monitoring the status of the various components and subsystems of the fuel cell system 300. In this manner, the controller 340 may include input communication lines 342 for purposes of receiving status information from the fuel cell system 300; and the controller 340 may communicate through output communication lines 344 to control various components of the fuel cell system 300. For example, the controller 340 may control the flow of fuel through the reformer 319 for purposes of optimizing the efficiency of the fuel cell stack. Furthermore, the controller 340 may control the output power level of the fuel cell system 300, among its various other functions.

Other embodiments are within the scope of the following claims. For example, in some embodiments of the invention, one type of adhesive (a cement, such as Loctite 332 high temperature acrylic cement) may be used to form a seal around the flow areas between two adjacent bipolar flow plates, and another type of adhesive (a cement, such as a high temperature epoxy) may be used to form a strong bond between the bipolar flow plates. The use of two different adhesive types may be beneficial due to the nature of the substances that are produced by the membranes and contained in the coolant flows. More particularly, in some embodiments of the invention, the coolant flow may contain petroleum that may adversely affect some types of adhesive; and the membrane (a PBI membrane, for example) may produce relatively concentrated phosphoric acid that may also adversely affect some types of adhesive.

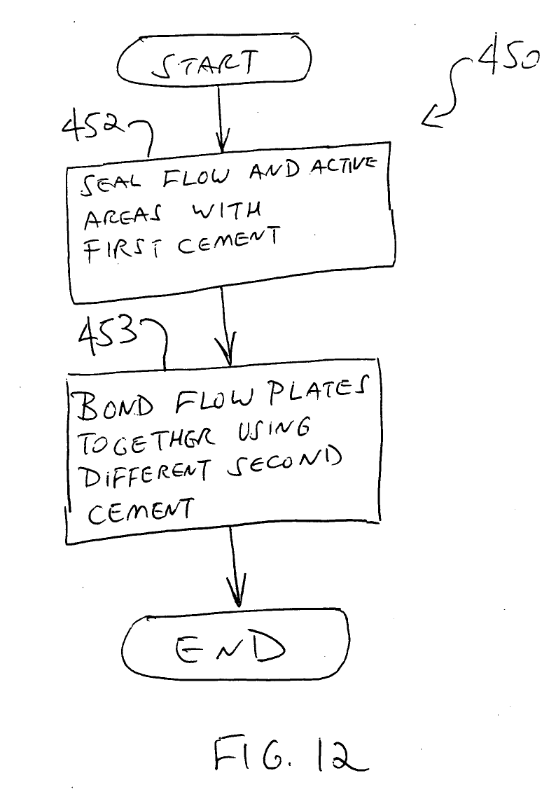

Thus, the above-described adhesives may be two different types of cement, in some embodiments of the invention. Referring to FIG. 12, in accordance with some embodiments of the invention, a technique 450 to assemble a fuel cell stack includes, for each set of adjacent bipolar flow pates, sealing (block 452) the coolant and flow regions with a first cement. This first cement may be compatible (and thus, is not dissolved or otherwise degraded by, for example) with any phosphoric acid byproduct from the membrane as well as petroleum that is present in the coolant. However, the first cement may not have a sufficient bonding strength (when cured) to adequately hold the adjacent bipolar flow plates together. Therefore, the technique 450 also includes bonding (block 453) the flow plates together using a second cement (different from the first cement) that has sufficient bonding properties to secure the flow plates together. It is noted that the second cement may not be compatible with the one or more substances that are present in the active or flow areas of the flow plates. However, the first cement serves as a buffer to isolate the second cement from the substance(s).

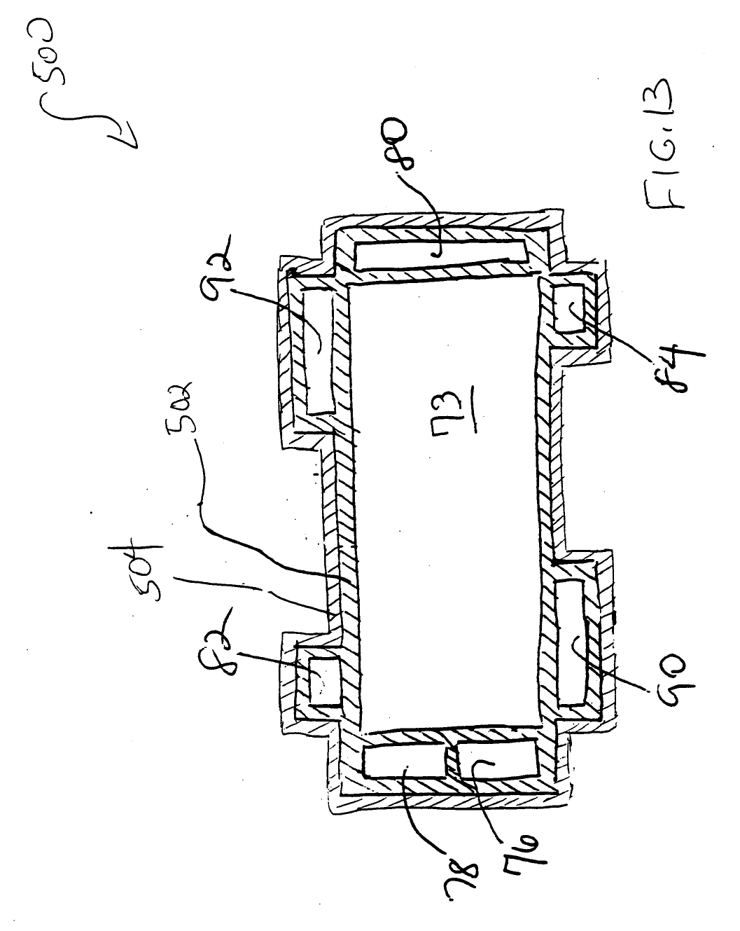

As a more specific example, FIG. 13 depicts a top view of a bipolar flow plate 500 in accordance with some embodiments of the invention. The bipolar flow plate 500 has a similar design to the bipolar flow plate 34 (see FIG. 5), with like reference numerals being used to point out similar features. However, unlike the bipolar flow plate 34, two regions are created on the top surface of the bipolar flow plate 500 to secure the flow plate 500 to an upper bipolar flow plate (not depicted in FIG. 13): a first inner seal region 502 in which a first cement layer that is compatible with all substances in the flow/active areas is disposed; and a second outer bond region 504 in which a second cement layer that forms a bond with the upper bipolar flow plate is disposed. The second cement layer may be incompatible with one or more substances in the flow/active areas. In some embodiments of the invention, both cement layers are electrically non-conductive.

Thus, as can be seen from FIG. 13, the inner seal region 502 seals off the active/flow areas and provides a buffer between these areas and the outer bond region 504. The outer bond region 504, in turn, secures the two bipolar flow plates together.

Although the outer bond region 504 is depicted in FIG. 13 as being a contiguous region around the inner seal region 502, the outer bond region 504 may not be contiguous in some embodiments of the invention. Therefore, in some embodiments of the invention, the outer bond region 504 may be formed from a set of bonding regions that are isolated from each other.

Lands and gutter grooves may be used in the surfaces of the bipolar flow plates, as described above, to receive the cement and form uniform thicknesses in the cement layers.

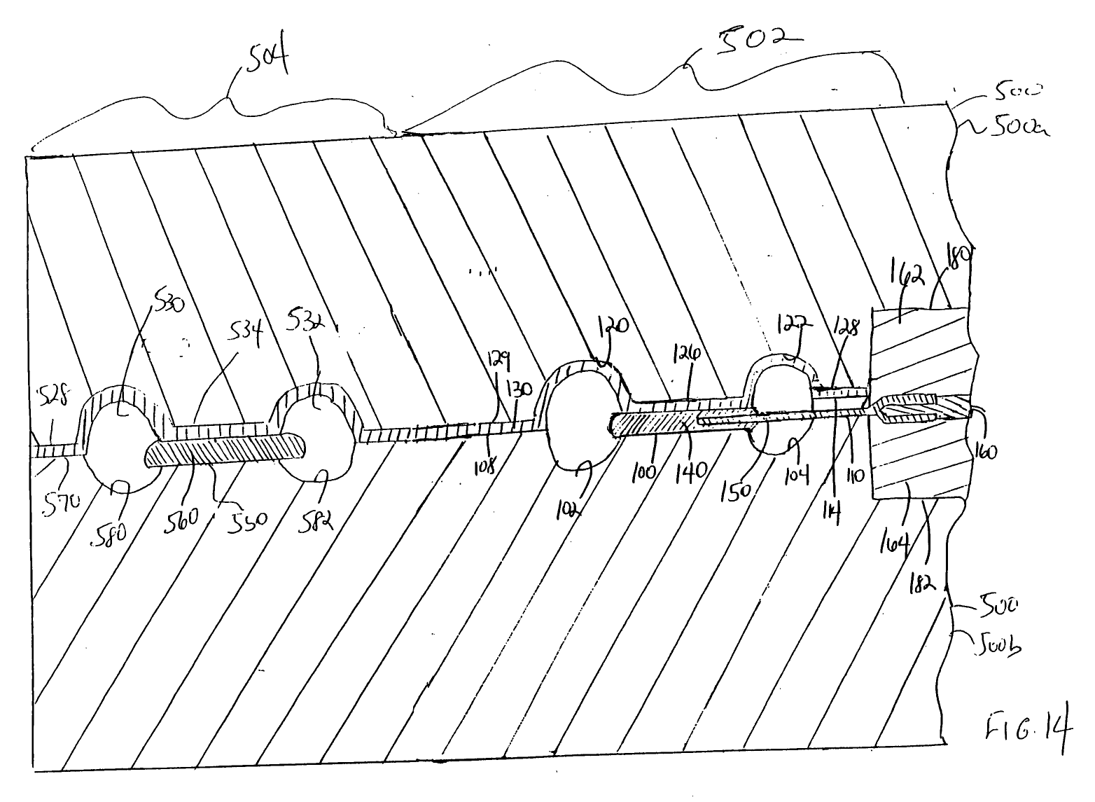

As a more specific example, FIG. 14 is a cross-sectional view of the inner seal region 502 and the outer bond region 504 for an adjacent upper bipolar flow plates 500a and a lower bipolar flow plate 500b that are assembled in a fuel cell stack. The inner seal region 502 has a structure similar to the seal region 74 (FIG. 4), with like reference numerals being used to point out similar features. Thus, the cement layer 140 depicted in FIG. 14 is the cement layer that is compatible with the flow and active areas and seals off these areas. The structure of the outer bond region 504 is described below.

In the outer bond region 504, the upper 500a and lower 500b bipolar flow plates form a groove of a predefined thickness to receive a bonding cement layer 560 as well as adjacent gutter groove passageways to receive excess cement when the layer 560 is formed. More particularly, in the outer bond region 504, the lower face of the upper bipolar flow plate 500a includes gutter grooves 530 and 532 that align with corresponding gutter grooves 580 and 582, respectively, to form the gutter groove passageways. The lower face of the upper bipolar flow plate 500a also includes a hard stop shoulder 528 that, in conjunction with a corresponding hard stop shoulder 570 of the lower bipolar flow plate 500b, defines the thickness of the bonding cement layer 560. As depicted in FIG. 14, the insulative layer 130 extends along the lower face of the upper bipolar flow plate 500a to electrically isolate the upper 500a and lower 500b bipolar flow plates from each other.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A fuel cell system, comprising:
a fuel cell stack comprising flow plates; and
a retainer to maintain a total compression force on the flow plates between approximately 5 to 40 pounds per square inch.

2. The fuel cell system of claim 1, wherein the retainer maintains a total compression force on the flow plates between approximately 5 to 40 pounds per square inch.

3. The fuel cell system of claim 1, wherein the retainer comprises a clip adapted to contact a first end and a second end of the fuel cell stack.

4. The fuel cell system of claim 1, wherein the retainer comprises a plastic clip.

5. The fuel cell system of claim 1, wherein the retainer comprises:
end plates located on a first end and a second end of the fuel cell stack; and
tie rods connecting the end plates together.

6. An apparatus comprising:
a first flow plate to communicate a fuel flow to an anode side of a fuel cell;
a second flow plate to communicate an oxidant flow to a cathode side of the fuel cell; and
a chemical to bond secure the first flow plate to the second flow plate.

7. The apparatus of claim 6, wherein the bond comprises an electrically non-conductive adhesive.

8. The apparatus of claim 6, wherein the bond comprises a weld.

9. The apparatus of claim 6, wherein the first flow plate comprises:
a land on which the bond is formed; and
at least one groove to receive excess material from the bond.

10. The apparatus of claim 9, wherein the bond comprises adhesive,
the adhesive is located on the land, and
the groove is adapted to receive excess adhesive when the first and second flow plates are mounted together.

11. A method comprising:
stacking fuel cell flow plates together to form a stack;
operating a mechanism so that at a position of the mechanism the mechanism applies a compression force on the stack initially exceeding a bond strength;
without changing the position of the mechanism, allowing an internal effect in the stack to relax the compression force to approximately be equal to or less than the bond strength; and
in response to the compression force relaxing below the bond strength, forming bonds between the plates.

12. The method of claim 11, wherein the act of allowing comprises:
allowing a membrane relaxation process in the stack to relax the compression force.

13. The method of claim 11, further comprising:
removing the stack from the mechanism after the formation of the bonds.

14. The method of claim 11, wherein the act of forming the bonds comprises:
allowing a cement to cure.

15. The method of claim 11, wherein the act of forming the bonds comprises:
welding the plates together.

16. A method usable with a fuel cell, comprising:
using a first flow plate and a second plate to form the fuel cell; and
forming a chemical bond to secure the first flow plate to the second flow plate and provide a seal to isolate flows of the fuel cell.

17. The method of claim 16, wherein the forming comprises:
using an adhesive to secure the first flow plate to the second flow plate.

18. The method of claim 16, wherein the forming comprises:
forming a weld between the first flow plate and the second flow plate.

19. The method of claim 16, further comprising:
forming a land on the first flow plate; and
forming a groove next to the land to receive excess material when the bond is formed.

20. The method of claim 19, further comprising:
forming a land to receive an adhesive to form the bond; and
forming at least one groove beside the land to receive excess adhesive when the first flow plate is assembled to the second flow plate.

21. A method usable with a fuel cell stack, comprising:
using a first adhesive layer between flow plates of the fuel cell stack to isolate flows in the fuel cell stack; and
using a second adhesive layer other than the first adhesive layer to bond the flow plates together.

22. The method of claim 21, wherein the second adhesive layer is less compatible with one or more substances of the flows than the first adhesive layer.

23. The method of claim 22, wherein said one or more substances comprises phosphoric acid.

24. The method of claim 22, wherein said one or more substances comprises a coolant.

25. The method of claim 21, wherein the second adhesive layer is adapted to form a stronger bond than the first adhesive layer.

26. The method of claim 21, wherein the flow plates comprise a first flow plate and a second flow plate, the method further comprising:
forming an inner seal between the first flow plate and the second flow plate to buffer the second flow plate to buffer the second adhesive layer from the flows.

27. The method of claim 26, wherein the second adhesive layer is contiguous.

28. The method of claim 21, wherein the first adhesive layer and the second adhesive layer comprise cement layers.

29. A fuel cell system comprising:
a fuel cell stack comprising flow plates;
a first adhesive layer located between the flow plates to isolate flows in the fuel cell stack; and
a second adhesive layer other than the first adhesive layer to bond the flow plates together.

30. The fuel cell system of claim 29, wherein the second adhesive layer is less compatible with one or more substances of the flows than the first adhesive layer.

31. The fuel cell system of claim 30, wherein said one or more substances comprises phosphoric acid.

32. The fuel cell system of claim 30, wherein said one or more substances comprises a coolant.

33. The fuel cell system of claim 29, wherein the flow plates comprise a first flow plate and a second flow plate, the fuel cell system further comprising:
an inner seal formed from the first adhesive layer and located between the first flow plate and the second flow plate to buffer the second adhesive layer from the flows.

34. The fuel cell system of claim 33, wherein the second adhesive layer is contiguous.

35. The fuel cell system of claim 29, wherein the first adhesive layer and the second adhesive layer comprise cement layers.
